(19) United States
(12) Patent Application Publication
(10) Pub. No.: US 2018/0047028 A1
(43) Pub. Date: Feb. 15, 2018

(54) REAL-TIME ALERTING SYSTEM

(71) Applicant: LinkedIn Corporation, Mountain View, CA (US)

(72) Inventors: Jing Feng, Cupertino, CA (US); Thomas Michael Lee, San Francisco, CA (US); Hailin Wu, Palo Alto, CA (US); Dakan Wang, Mountain View, CA (US); Bo Hu, Mountain View, CA (US); Abhishek Gupta, San Francisco, CA (US); Sanjay Kshetramade, Fremont, CA (US)

(21) Appl. No.: 15/234,202

(22) Filed: Aug. 11, 2016

(51) Int. Cl. G06Q 30/00; G06Q 50/00

(52) U.S. Cl. CPC G06Q 30/01; G06Q 50/01

(57) ABSTRACT

A system, a machine-readable storage medium storing instructions, and a computer-implemented method as described herein are directed to a Sales Lead Engine that links external data to social network data from a social network service. The Sales Lead Engine determines the external data and the social network data satisfy a sales lead criterion. The Sales Lead Engine identifies an organization account in the social network service identified by the external data and the social network data. The Sales Lead Engine provides a sales lead notification to a target member account based on a selection by the target member account to follow the organization account in the social network service.

### TECHNICAL FIELD

The present disclosure generally relates to data processing systems. More specifically, the present disclosure relates to methods, systems and computer program products for generating notifications in a social network service.

### BACKGROUND

A social networking service is a computer- or web-based application that enables users to establish links or connections with persons for the purpose of sharing information with one another. Some social networking services aim to enable friends and family to communicate with one another, while others are specifically directed to business users with a goal of enabling the sharing of business information. For purposes of the present disclosure, the terms “social network” and “social networking service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks”).

With many social networking services, members are prompted to provide a variety of personal information, which may be displayed in a member's personal web page. Such information is commonly referred to as personal profile information, or simply “profile information”, and when shown collectively, it is commonly referred to as a member's profile. For example, with some of the many social networking services in use today, the personal information that is commonly requested and displayed includes a member's age, gender, interests, contact information, home town, address, the name of the member's spouse and/or family members, and so forth. With certain social networking services, such as some business networking services, a member's personal information may include information commonly included in a professional resume or curriculum vitae, such as information about a person's education, employment history, skills, professional organizations, and so on. With some social networking services, a member's profile may be viewable to the public by default, or alternatively, the member may specify that only some portion of the profile is to be public by default. Accordingly, many social networking services serve as a sort of directory of people to be searched and browsed.

### DESCRIPTION OF THE DRAWINGS

Some embodiments are illustrated by way of example and not limitation in the figures of the accompanying drawings in which:

FIG. 1 is a block diagram illustrating a client-server system, in accordance with an example embodiment;

FIG. 2 is a block diagram showing functional components of a professional social network within a networked system, in accordance with an example embodiment;

FIG. 3 is a block diagram showing example components of a Sales Lead Engine, according to an example embodiment;

FIG. 4 illustrates a schematic diagram of data flow in a Sales Lead Engine, according to an example embodiment;

FIG. 5 is a flowchart illustrating an example method for providing a sales lead notification, according to an example embodiment;

FIG. 6 is a flowchart illustrating an example method for identifying changes in senior leadership of a social network, according to an example embodiment;

FIG. 7 is a block diagram of an example computer system on which methodologies described herein may be executed, in accordance with an example embodiment.

### DETAILED DESCRIPTION

The present disclosure describes methods and systems for sending a notification to a target member account in a professional social networking service (also referred to herein as a “professional social network” or “social network” or “social network service”) based on satisfaction of one or more sales lead criterion. In the following description, for purposes of explanation, numerous specific details are set forth in order to provide a thorough understanding of the various aspects of different embodiments of the present invention described herein. It will be evident, however, to one skilled in the art, that the disclosed systems and methods may be practiced without all of the specific details.

A system, a machine-readable storage medium storing instructions, and a computer-implemented method as described herein are directed to a Sales Lead Engine that links external data to social network data maintained by a social network service. The Sales Lead Engine determines whether the external data and the social network data satisfy at least one sales lead criterion from a plurality of sales lead criteria. The Sales Lead Engine identifies an organization account in the social network service identified by the external data and the social network data. The Sales Lead Engine provides a sales lead notification to a target member account based on a selection by the target member account to follow the organization account in the social network service. For example, a sales lead notification can be a sending a social network message to the target member account. Due to sending the sales lead notification, the Sales Lead Engine initiates display of an alert of in a social network content feed page of the target member account.

According to various embodiments, the Sales Lead Engine integrates different sources of data to generate standardized notifications for a target member account based on satisfied sales criterion. The Sales Lead Engine syncs external data and social network data in order to identify data insights about an organization account in the social network service. Such data insights are indicative of sales opportunities for a target member account that is following the organization account in the social network service. For example, the Sales Lead Engine receives customer relationship management (CRM) data from a CRM platform external to the social network service. The CRM data includes updated employment attribute data associated with an identity that has a corresponding member account in the social network service. However, there may be a discrepancy between the CRM data and profile data of the member account in the social network service.

The Sales Lead Engine determines whether the discrepancy satisfies at least one of a sales lead criterion. For example, the Sales Lead Engine identifies an employment role change event based on a difference in a job title attribute in the CRM data and a job title attribute in social network profile data of the corresponding member account. The difference in job title attributes represents that the person represented by both the CRM data and the corresponding member account in the social network service has changed their employment role even though social network profile data of the corresponding member account may not have yet been updated. Such a change in employment role is a valuable insight in terms of a sales lead opportunity for the target member account.

The Sales Lead Engine determines whether the target member account has selected to follow an organization account in the social network service for an organization at which the person represented by the CRM data and the corresponding member is employed. Based on the employment role change event and the target member account following the organization account, the Sales Lead Engine generates a notification and provides the notification to the target member account. The notification describes the employment role change event and identifies the corresponding member account. Receipt of the notification in the social network service thereby prompts the target member account to contact the corresponding member account in order to inquire whether the person represented by the corresponding member account in the notification may need to purchase additional or new services in light of their new professional responsibilities.

In another embodiment, the Sales Lead Engine performs all the operations and action described herein with raw profile data in the social network service as opposed to CRM data. Stated differently, all the operations described herein with respect to the use of CRM data can be performed by the Sales Lead Engine using raw profile data of a member account in the social network service.

It is understood that various embodiments further include encoded instructions that comprise operations to generate a user interface(s) and various user interface elements. The user interface and the various user interface elements can be displayed to be representative of any of the operations, CRM data, social network data, sales lead criteria, sales lead data, and notifications, as described herein. In addition, the user interface and various user interface elements are generated by the Sales Lead Engine for display on a computing device, a server computing device, a mobile computing device, etc.

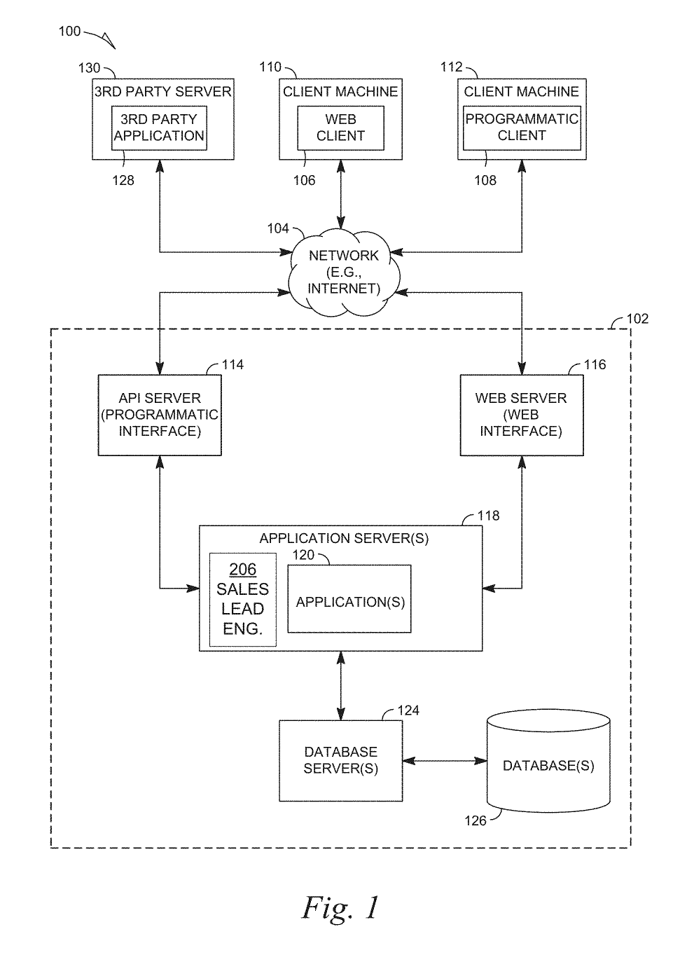

Turning now to FIG. 1 is a block diagram illustrating a client-server system, in accordance with an example embodiment. A networked system 102 provides server-side functionality via a network 104 (e.g., the Internet or Wide Area Network (WAN)) to one or more clients, FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102. In some embodiments, the networked system 102 may comprise functional components of a professional social network.

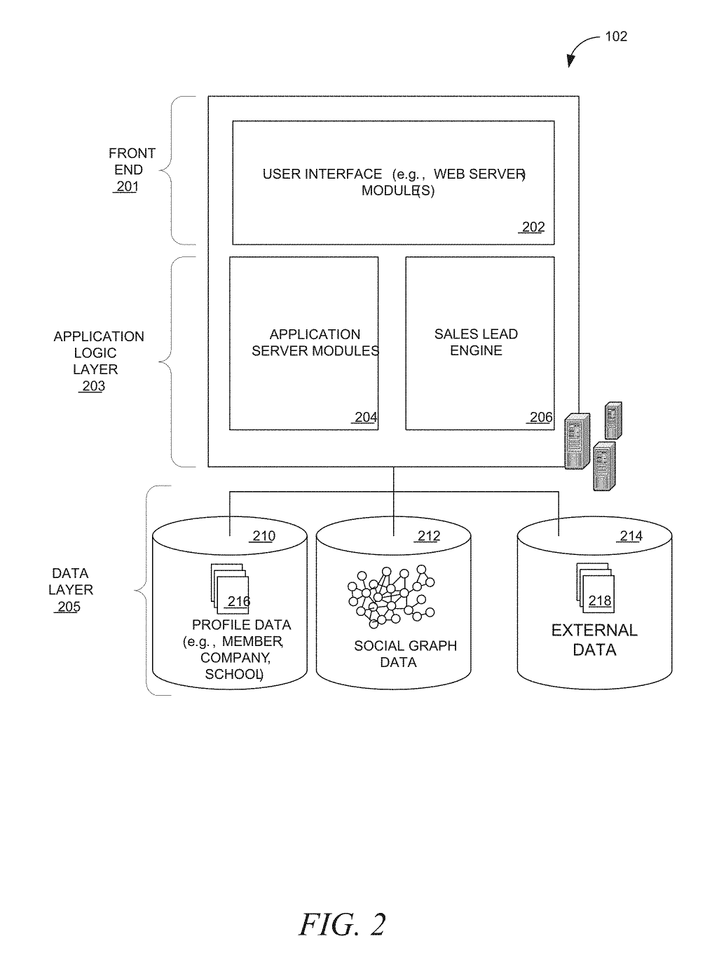

FIG. 2 is a block diagram showing functional components of a professional social network within the networked system 102, in accordance with an example embodiment.

As shown in FIG. 2, the professional social network may be based on a three-tiered architecture, consisting of a front-end layer 201, an application logic layer 203, and a data layer 205. In some embodiments, the modules, systems, and/or engines shown in FIG. 2 represent a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 2. However, one skilled in the art will readily recognize that various additional functional modules and engines may be used with a professional social network, such as that illustrated in FIG. 2, to facilitate additional functionality that is not specifically described herein. Furthermore, the various functional modules and engines depicted in FIG. 2 may reside on a single server computer, or may be distributed across several server computers in various arrangements. Moreover, although a professional social network is depicted in FIG. 2 as a three-tiered architecture, the inventive subject matter is by no means limited to such architecture. It is contemplated that other types of architecture are within the scope of the present disclosure.

As shown in FIG. 2, in some embodiments, the front-end layer 201 comprises a user interface module (e.g., a web server) 202, which receives requests and inputs from various client-computing devices, and communicates appropriate responses to the requesting client devices. For example, the user interface module(s) 202 may receive requests in the form of Hypertext Transport Protocol (HTTP) requests, or other web-based, application programming interface (API) requests.

In some embodiments, the application logic layer 203 includes various application server modules 204, which, in conjunction with the user interface module(s) 202, generates various user interfaces (e.g., web pages) with data retrieved from various data sources in the data layer 205. In some embodiments, individual application server modules 204 are used to implement the functionality associated with various services and features of the professional social network. For instance, the ability of an organization to establish a presence in a social graph of the social network service, including the ability to establish a customized web page on behalf of an organization, and to publish messages or status updates on behalf of an organization, may be services implemented in independent application server modules 204. Similarly, a variety of other applications or services that are made available to members of the social network service may be embodied in their own application server modules 204.

As shown in FIG. 2, the data layer 205 may include several databases, such as a database 210 for storing profile data 216, including both member profile attribute data as well as profile attribute data for various organizations. Consistent with some embodiments, when a person initially registers to become a member of the professional social network, the person will be prompted to provide some profile attribute data such as, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information may be stored, for example, in the database 210. Similarly, when a representative of an organization initially registers the organization with the professional social network the representative may be prompted to provide certain information about the organization. This information may be stored, for example, in the database 210, or another database (not shown). With some embodiments, the profile data 216 may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or a seniority level within a particular company. With some embodiments, importing or otherwise accessing data from one or more externally hosted data sources may enhance profile data 216 for both members and organizations. For instance, with companies in particular, financial data may be imported from one or more external data sources, and made part of a company's profile. Such profiled data 216 and profile attribute data may be utilized by the Sale Lead Engine 206 in determining whether one or more sales lead criteria has been satisfied.

The profile data 216 may also include information regarding settings for members of the professional social network. These settings may comprise various categories, including, but not limited to, privacy and communications. Each category may have its own set of settings that a member may control.

Once registered, a member may invite other members, or be invited by other members, to connect via the professional social network. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, may be stored and maintained as social graph data within a social graph database 212.

The professional social network may provide a broad range of other applications and services that allow members the opportunity to share and receive information, often customized to the interests of the member. For example, with some embodiments, the professional social network may include a photo sharing application that allows members to upload and share photos with other members. With some embodiments, members may be able to self-organize into groups, or interest groups, organized around a subject matter or topic of interest. With some embodiments, the professional social network may host various job listings providing details of job openings with various organizations.

In some embodiments, the professional social network provides an application programming interface (API) module via which third-party applications can access various services and data provided by the professional social network. For example, using an API, a third-party application may provide a user interface and logic that enables an authorized representative of an organization to publish messages from a third-party application to a content hosting platform of the professional social network (also referred herein as a social network service) that facilitates presentation of activity or content streams maintained and presented by the professional social network. Such third-party applications may be browser-based applications, or may be operating system-specific. In particular, some third-party applications may reside and execute on one or more mobile devices (e.g., a smartphone, or tablet computing devices) having a mobile operating system.

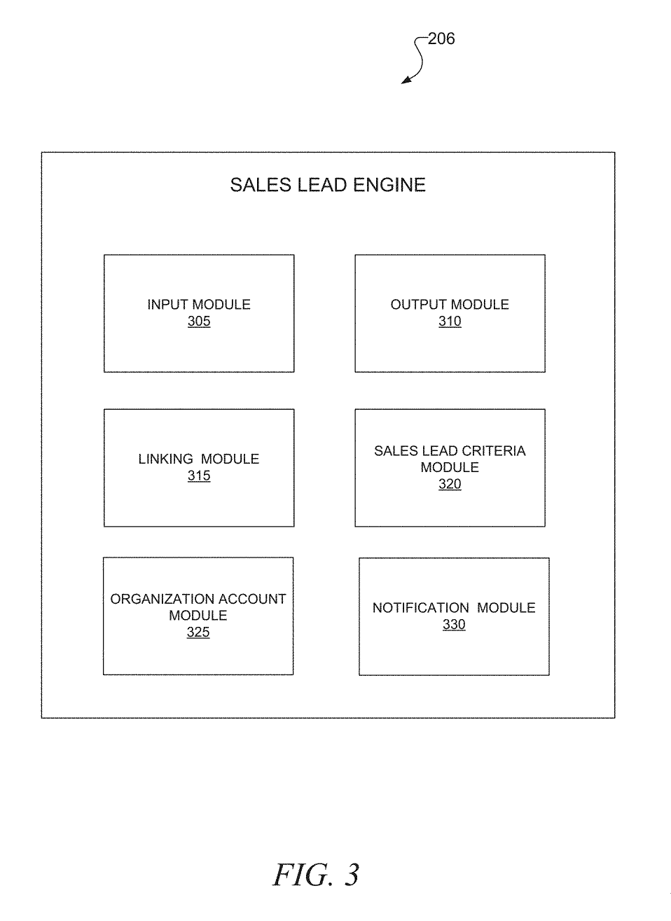

The data layer 205 further includes a database 214 that stores one or more portions of external data 218 received from a data source external to the professional social network. The data in the data layer 205 may be accessed, used, and adjusted by Sales Lead Engine 206 as will be described in more detail below in conjunction with FIGS. 3-7. Although the Sales Lead Engine 206 is referred to herein as being used in the context of a professional social network, it is contemplated that it may also be employed in the context of any website or online services, including, but not limited to, content sharing sites (e.g., photo- or video-sharing sites) and any other online services that allow users to have a profile and present themselves or content to other users. Additionally, although features of the present disclosure are referred to herein as being used or presented in the context of a web page, it is contemplated that any user interface view (e.g., a user interface on a mobile device or on desktop software) is within the scope of the present disclosure.

FIG. 3 is a block diagram showing example components of a Sales Lead Engine 206, according to an example embodiment. While the modules 305, 310, 315, 320, 325, and 330 are described as performing specific operations, one of ordinary skill in the art will appreciate that such modules may be configured to perform alternative and/or additional operations.

In one embodiment, the input module 305 is a hardware-implemented module that controls, manages and stores information related to any inputs from one or more components of system 102 as illustrated in FIG. 1 and FIG. 2. In various embodiments, the inputs include external data (such as CRM data) and social network data.

In one embodiment, the output module 310 is a hardware-implemented module that controls, manages and stores information related to which sends any outputs to one or more components of system 100 of FIG. 1 (e.g., one or more client devices 110, 112, third party server 130, etc.). In some embodiments, the output is a sales lead notification for each of one or more target member accounts.

In one embodiment, the linking module 315 is a hardware-implemented module which manages, controls, stores, and accesses information related to linking data fields and attributes in external data to related data fields and attributes in social network data. In various embodiments, such linking of related data fields and attributes occurs for external data associated with an identity and a member account in the social network service that corresponds to a matching identity. The linking module 315 further combines linked data fields and attributes to generate sales lead data.

In one embodiment, the sales lead criteria module 320 is a hardware-implemented module which manages, controls, stores, and accesses information related to applying one or more sales lead criterion to sales lead data to identify a sales lead opportunity.

In one embodiment, the organization account module 325 is a hardware-implemented module which manages, controls, stores, and accesses information related to identifying an organization account in the social network service identified by at least one of the external data and the social network data. organization account module 325 selects a data field or an attribute (such as a current employer attribute) in the external data or the social network data that identifies an organization. The organization account module 325 identifies a corresponding organization account in the social network service that corresponds with the identified organization.

In one embodiment, the notification module 330 is a hardware-implemented module which manages, controls, stores, and accesses information related to providing a sales lead notification to a target member account based on a selection by the target member account to follow the organization account in the social network service. In various embodiments, based on at least one sales lead criterion being satisfied and an organization account being identified, the notification module 330 generates a sales lead notification for a target member account that is currently following the organization account in the social network service.

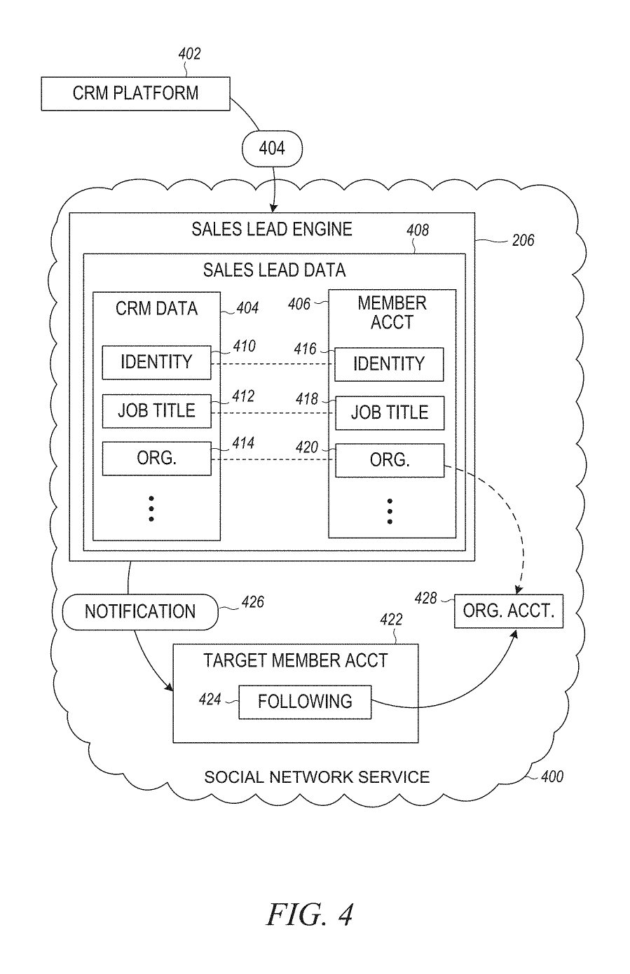

FIG. 4 illustrates a schematic diagram of data flow in a Sales Lead Engine 206, according to an example embodiment.

The Sale Lead Engine 206 receives customer relationship management (CRM) data 404 from a CRM platform 402 external to the social network service 400. For example, the CRM platform and the social network service 400 perform regularly scheduled synchronizations (e.g. hourly, daily, weekly) in which the CRM data 404 is imported through a social network service interface to be stored at one or more memory locations within the social network service 400.

The Sales Lead Engine 206 identifies an identity attribute 410 in the CRM data 404 that corresponds to an identity attribute 416 of a member account in the social network service 400. For example, the Sales Lead Engine 206 compares text in data fields of the identity attributes 410, 416 to determine whether a match exists. In another example, the identity attribute 410 in the CRM data 410 includes an identifier and the Sales Lead Engine 206 includes an identifier mapping listing that includes pairings between CRM identifiers and respective member accounts. The Sales Lead Engine 206 accesses the identifier mapping listing and locates the identifier and the respective member account paired with the identifier.

In response to determining that the CRM data 404 corresponds to a member account 406 in the social network service 400, the Sales Lead Engine 206 generates sales lead data 408 by generating a combination of the CRM data 404 and social network data 416, 418, 420 associated with the member account 406. The sales lead data 408 includes links between similar data fields 401, 412, 414 of the CRM data 404 and the social network data 416, 418, 420 associated with the member account 406. The Sales Lead Engine 206 processes the sales lead data 408 to produce insights as to when a unique sales opportunity for a target member account 422 may be occurring. The Sales Lead Engine 206 applies one or more sales lead criterion to a portion(s) of the sales lead data 408 to identify respective sales opportunities.

In one embodiment, a first sales lead criteria is satisfied in response to the Sales Lead Engine 206 identifying an employer change event in the sales lead data 408. For example, the Sales Lead Engine 206 detects a difference in an employer attribute 414 that identifies an organization in the CRM data 404 and an employer attribute 420 in social network profile data of the member account 206. The difference in employer attributes 414, 420 indicates the person represented by the member account 206 has recently started a job at a new organization but has yet to update their social network profile data. The difference in employer attributes 414, 420 is defined by the Sales Lead Engine 206 as satisfying the first sales lead criteria because people may be interested in purchasing new or additional services when they begin a professional role with a new organization.

In addition, and in one embodiment, a second sales lead criteria is satisfied in response to the Sales Lead Engine 206 identifying an employment role change event in the sales lead data 408.

For example, the Sales Lead Engine 206 detects a difference in a job title attribute 412 in the CRM data 404 and a job title attribute 418 in social network profile data of the member account 206. The difference in job title attributes 412, 418 indicates the person represented by the member account 206 has recently started a new job within their current organization. The difference in job title attributes 412, 418 is defined by the Sales Lead Engine 206 as satisfying the second sales lead criterion because people may be interested in purchasing new or additional services when they begin a new professional role. It is understood that various embodiments are not limited to the first and second sales criteria.

The Sales Lead Engine 206 identifies an organization account 428 in the social network service 400 identified by at least one of the external data and the social network data. The Sales Lead Engine 206 identifies an organization account 428 that is identified by one or more of the employer attributes 414, 420 in the sales lead data 408. For example, if the employer attribute 420 in the social network profile data of the member account 406 represents “Company A,” the Sales Lead Engine 206 identifies an organization account 428 in the social network service 400 for Company A. The Sales Lead Engine 206 identifies one or more member accounts that have selected to follow 424 the organization account 428 for “Company A”. The Sales Lead Engine 206 determines the target member account 422 has selected to follow 424 the organization account 424 for “Company A” in the social network service 400. Based on at least one sales criterion being satisfied, the Sales Lead Engine 206 generates a sales lead notification 426 and transmits the notification 426 to the target member account 422 due to the target member account 422 having selected to follow 424 the organization account 428.

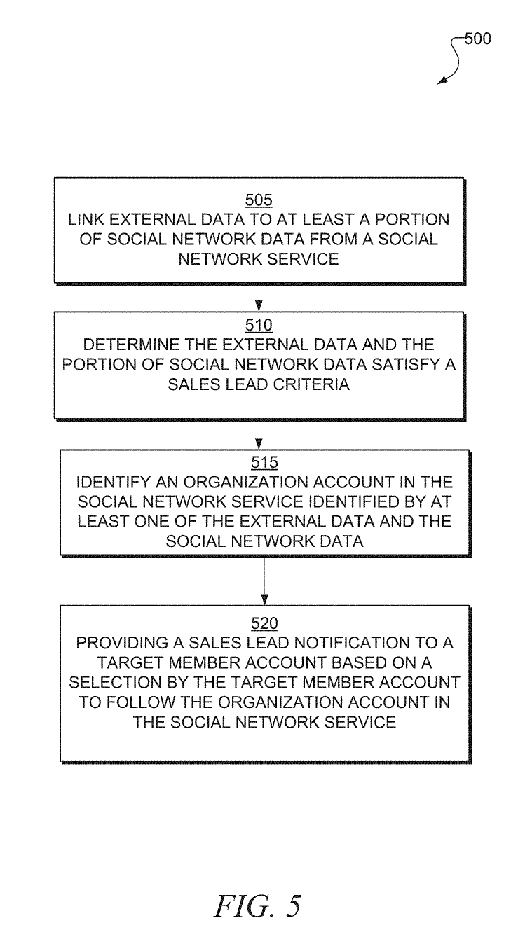

FIG. 5 is a flowchart illustrating an example method 500 for providing a sales lead notification, according to an example embodiment. Initially, at operation 505, the Sales Lead Engine 206 links external data to at least a portion of social network data from a social network service. For example, the Sales Lead Engine 206 integrates CRM data from a CRM platform external to a social network service. The CRM data includes identity data that matches identity attributes in profile data of a member account in the social network service. It is understood that identity data and identity attributes can be can be a person's name, a user name, an account identifier, an employee identifier, or other such identity data or combinations thereof. The Sales Lead Engine 206 links a portion of external data to a portion of social network data in response to detecting a match between their respective values, text, or identifiers. The Sales Lead Engine 206 generates a linkage instantiating a data relationship between the matching portions of external data and social network data.

At operation 510, the Sales Lead Engine 206 determines whether the external data and the portion of social network data satisfy a sales lead criterion. Various examples of a sales lead criterion can be based solely on changes in social network data. A sales lead criterion can be satisfied when the Sales Lead Engine 206 detects that a unit (or department) of a company represented by an organization account in the social network service has experienced a threshold amount of headcount growth during a particular time range. For example, the Sales Lead Engine 206 detects that a plurality of member accounts have each updated their respective profile data to reflect employment in an engineering department of Company B. The Sales Lead Engine 206 determines a total number of profile data updates from the plurality of member accounts during a time range, such as during the most recent two or three months. The Sales Lead Engine 206 compares the total number of profile data updates against a threshold value and the sales lead criteria is satisfied upon determining the threshold value is met or exceeded. Another sales lead criterion can be satisfied based on the Sales Lead Engine 206 detecting that a number of new job postings from an organization account have been posted in the social network service during a particular time range. For example, the Sales Lead Engine 206 determines a total number of new job postings from Company C have been uploaded to the social network service during the most recent 10 weeks. The Sales Lead Engine 206 compares the total number of new job postings against a threshold value and the sales lead criterion is satisfied based on the threshold value being met or exceeded.

At operation 515, the Sales Lead Engine 206 identifies an organization account in the social network service identified by at least one of the external data and the social network data. Continuing with the examples for Company B and Company C, the Sales Lead Engine 206 identifies the corresponding organization accounts in the social network service for both Company B and Company C.

At operation 520, the Sales Lead Engine 206 provides a sales lead notification to a target member account due to a selection by the target member account to follow the organization account in the social network service. Based on a satisfied sales lead criterion, the Sales Lead Engine 206 sends notifications to one or more target member accounts that are following the organization account for Company B and the Sales Lead Engine 206 sends notifications to one or more target member accounts that are following the organization account for Company C.

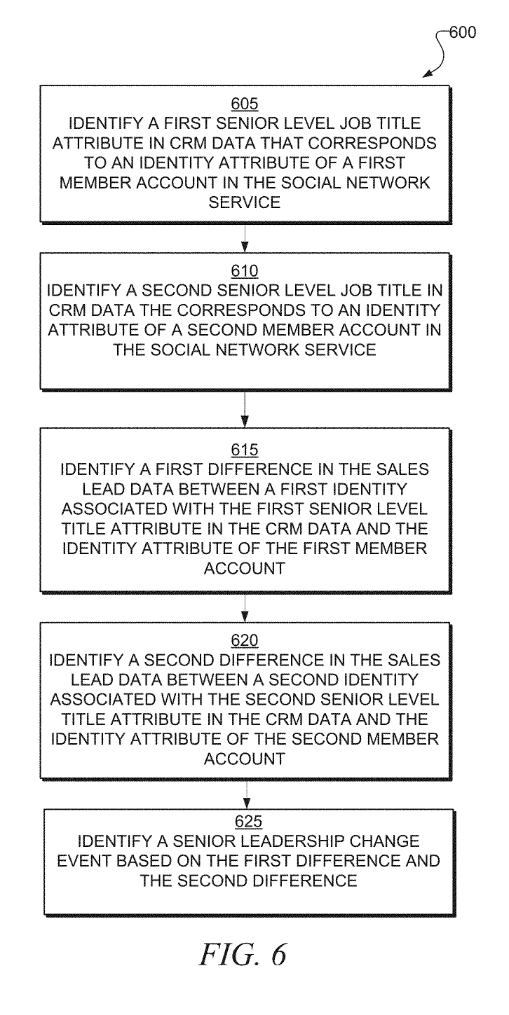

FIG. 6 is a flowchart illustrating an example method 600 for identifying chances in senior leadership of a social network, according to an example embodiment. Initially, at operation 605, the Sales Lead Engine 206 identifies a first senior level job title attribute in CRM data that corresponds to an identity attribute of a first member account in the social network service. For example, the Sales Lead Engine 206 identifies a senior level job title, such as “Senior Vice President” for a particular organization in CRM data and identifies a first member account in the social network that has profile data with the same senior level job title (“Senior Vice President”) for the same particular organization.

At operation 610, the Sales Lead Engine 206 identifies a second senior level job title in CRM data that corresponds to an identity attribute of a second member account in the social network service. For example, the Sales Lead Engine 206 identifies another senior level job title, such as “C.O.O” for the particular organization in CRM data and identifies a second member account in the social network that has profile data with the same senior level job title (“C.O.O.”) for the same particular organization.

At operation 615, the Sales Lead Engine 206 identifies a first difference in the sales lead data between a first identity associated with the first senior level title attribute in the CRM data and the identity attribute of the first member account. The Sales Lead Engine 206 accesses the CRM data to extract a first identity (such as a name) of an individual listed in the CRM data as the “Senior Vice President” for the particular organization. The Sales Lead Engine 206 compares the first identity from the CRM data to the profile data of the first member account to determine that the first identity from the CRM data identifies a different person than a user of the first member account. Such a difference represents that the particular organization has hired a new “Senior Vice President”.

At operation 620, the Sales Lead Engine 206 identifies a second difference in the sales lead data between a second identity associated with the second senior level title attribute in the CRM data and the identity attribute of the second member account. The Sales Lead Engine 206 accesses the CRM data to extract a second identity (such as a name) of an individual listed in the CRM data as the “C.O.O.” for the particular organization. The Sales Lead Engine 206 compares the second identity from the CRM data to the profile data of the second member account to determine that the second identity from the CRM data identifies a different person than a user of the second member account. Such a difference represents that the particular organization has also hired a new “C.O.O.”.

At operation 625, the Sales Lead Engine 206 identifies a senior leadership change event based on the first difference and the second difference. The Sales Lead Engine 206 determines a sales lead criteria as been satisfied due to detecting multiple changes in senior leadership in the same organization during a particular time range. Such a drastic change in senior leadership represents a sale opportunity since a new team of senior level corporate officers may be more inclined to purchase new or additional services or change outside vendors.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory strictures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

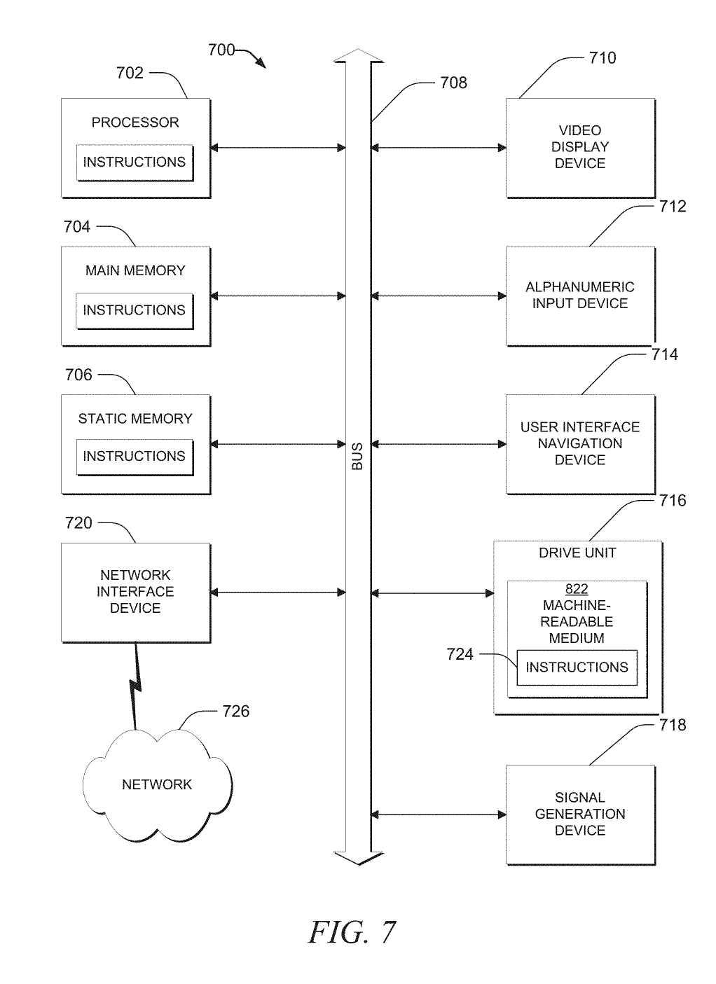

FIG. 7 is a block diagram of a machine in the example form of a computer system 700 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 700 includes a processor 702 (e.g., a central processing unit (CPU), a graphics processing unit (GPU) or both), a main memory 704, and a static memory 706, which communicate with each other via a bus 708. Computer system 700 may further include a video display device 710 (e.g., a liquid crystal display (LCD) or a cathode ray tube (CRT)). Computer system 700 also includes an alphanumeric input device 712 (e.g., a keyboard), a user interface (UI) navigation device 714 (e.g., a mouse or touch sensitive display), a disk drive unit 716, a signal generation device 718 (e.g., a speaker) and a network interface device 720.

Disk drive unit 716 includes a machine-readable medium 722 on which is stored one or more sets of instructions and data structures (e.g., software) 724 embodying or utilized by any one or more of the methodologies or functions described herein. Instructions 724 may also reside, completely or at least partially, within main memory 704, within static memory 706, and/or within processor 702 during execution thereof by computer system 700, main memory 704 and processor 702 also constituting machine-readable media.

While machine-readable medium 722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present technology, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

Instructions 724 may further be transmitted or received over a communications network 726 using a transmission medium. Instructions 724 may be transmitted using network interface device 720 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMAX networks). The term “transmission medium” shall be taken to include any intangible medium that is capable of storing, encoding or carrying instructions for execution by the machine; and includes digital or analog communications signals or other intangible media to facilitate communication of such software.

Although an embodiment has been described with reference to specific example embodiments, it will be evident that various modifications and changes may be made to these embodiments without departing from the broader spirit and scope of the technology. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer system, comprising:
a processor;
a memory device storing an instruction set executable by the processor to configure the computer system to perform operations comprising:
linking external data to at least a portion of social network data from a social network service;
determining the external data and the portion of social network data satisfy a sales lead criterion;
identifying an organization account in the social network service identified by at least one of the external data and the social network data; and
providing a sales lead notification to a target member account based on a selection by the target member account to follow the organization account in the social network service.

2. The computer system of claim 1, wherein linking external data to at least a portion of social network data from a social network service comprises:
receiving customer relationship management (CRM) data from a CRM platform external to the social network service;
identifying an identity attribute in the CRM data that corresponds to an identity attribute of a member account in the social network service; and
generating sales lead data based on a combination of the CRM data and social network data associated with the member account.

3. The computer system of claim 2, wherein determining the external data and the portion of social network data satisfy the sales lead criterion comprises:
identifying an employment role change event in the sales lead data based on a difference in a job title attribute in the CRM data and a job title attribute in social network profile data of the member account.

4. The computer system of claim 2, wherein determining the external data and the portion of social network data satisfy the sales lead criterion comprises:
identifying an employer change event in the sales lead data based on a difference in an employer attribute in the CRM data and an employer attribute in social network profile data of the member account.

5. The computer system of claim 4, wherein identifying an organization account in the social network service identified by at leak one of the external data and the social network data comprises:
determining the employer attribute in the CRM data identifies the organization account.

6. The computer system of claim 2, wherein identifying an identity attribute in the CRM data that corresponds to an identity attribute of a member account in the social network service comprises:
identifying a first senior level job title attribute in CRM data the corresponds to an identity attribute of a first member account in the social network service; and
identifying a second senior level job title in CRM data corresponds to an identity attribute of a second member account in the social network service.

7. The computer system of claim 6, wherein determining the external data and the portion of social network data satisfy the sales lead criterion comprises:
identifying a first difference in the sales lead data between a first identity associated with the first senior level title attribute in the CRM data and the identity attribute of the first member account;
identifying a second difference in the sales lead data between a second identity associated with the second senior level title attribute in the CRM data and the identity attribute of the second member account; and
identifying a senior leadership change event based on the first difference and the second difference.

8. The computer system of claim of 1, wherein providing a sales lead notification to a target member account based on a selection by the target member account to follow the organization account in the social network service comprises:
sending a social network message to the target member account; and
initiating display of an alert of in a social network content feed page of the target member account.

9. A non-transitory computer-readable medium storing executable instructions thereon, which, when executed by a processor, cause the processor to perform operations including:
linking external data to at least a portion of social network data from a social network service;
determining the external data and the portion of social network data satisfy a sales lead criterion;
identifying an organization account in the social network service identified by at least one of the external data and the social network data; and
providing a sales lead notification to a target member account based on a selection by the target member account to follow the organization account in the social network service.

10. The non-transitory computer-readable medium of claim 9, wherein linking external data to at least a portion of social network data from a social network service comprises:
receiving customer relationship management (OM) data from a CRM platform external to the social network service;
identifying an identity attribute in the CRM data that corresponds to an identity attribute of a member account in the social network service; and
generating sales lead data based on a combination of the CRM data and social network data associated with the member account.

11. The non-transitory computer-readable medium of claim 10, wherein determining the external data and the portion of social network data satisfy a sales lead criterion comprises:
identifying an employment role change event in the sales lead data based on a difference in a job title attribute in the CRM data and a job title attribute in social network profile data of the member account.

12. The non-transitory computer-readable medium of claim 10, wherein determining the external data and the portion of social network data satisfy a sales lead criterion comprises:
identifying an employer change event in the sales lead data based on a difference in an employer attribute in the CRM data and an employer attribute in social network profile data of the member account.

13. The non-transitory computer-readable medium of claim 12, wherein identifying an organization account in the social network service identified by at least one of the external data and the social network data comprises:
determining the employer attribute in the CRM data identifies the organization account.

14. The non-transitory computer-readable medium of claim 10, wherein identifying an identity attribute in the CRM data that corresponds to an identity attribute of a member account in the social network service comprises:
identifying a first senior level job title attribute in CRM data the corresponds to an identity attribute of a first member account n the social network service; and
identifying a second senior level job title in CRM data the corresponds to an identity attribute of a second member account in the social network service.

15. The non-transitory computer-readable medium of claim 14, wherein determining the external data and the portion of social network data satisfy a sales lead criterion comprises:
identifying a first difference in the sales lead data between a first identity associated with the first senior level title attribute in the CRM data and the identity attribute of the first member account;
identifying a second difference in the sales lead data between a second identity associated with the second senior level title attribute in the CRM data and the identity attribute of the second member account; and
identifying an senior leadership change event based on the first difference and the second difference.

16. The non-transitory computer-readable medium of claim of 9, wherein providing a sales lead notification to a target member account based on a selection by the target member account to follow the organization account in the social network service comprises:

17. A computer-implemented method, comprising:
linking external data to at least a portion of social network data from a social network service;
determining, via at least one processor, the external data and the portion of social network data satisfy a sales lead criterion;
identifying an organization account in the social network service identified by at least one of the external data and the social network data; and
providing a sales lead notification to a target member account based on a selection by the target member account to follow the organization account in the social network service.

18. The computer-implemented method of claim 17, wherein linking external data to at least a portion of social network data from a social network service comprises:
receiving customer relationship management (CRM) data from a CRM platform external to the social network service;
identifying an identity attribute in the CRM data that corresponds to an identity attribute of a member account in the social network service; and
generating sales lead data based on a combination of the CRM data and social network data associated with the member account.

19. The computer-implemented method of claim 18, wherein determining the external data and the portion of social network data satisfy a sales lead criterion comprises:
identifying an employment role change event in the sales lead data based on a difference in a job title attribute in the CRM data and a job title attribute in social network profile data of the member account.

20. The computer-implemented method of claim 18, wherein determining the external data and the portion of social network data satisfy a sales lead criterion comprises:
identifying an employer change event in the sales lead data based on a difference in an employer attribute in the CRM data and an employer attribute in social network profile data of the member account.
